(19) United States
(12) Patent Application Publication
(10) Pub. No.: US 2013/0282737 A1
(43) Pub. Date: Oct. 24, 2013

(54) METHOD AND APPARATUS FOR INTELLIGENTLY DEPLOYING AN APPLICATION, METHOD AND APPARATUS FOR PROCESSING APPLICATION ACCESS, SYSTEM FOR INTELLIGENTLY DEPLOYING AND SCHEDULING AN APPLICATION

(71) Applicant: Huawei Technologies Co., Ltd., Shenzhen (CN)

(72) Inventors: Pu Chen, Shenzhen (CN); Zhiping Liang, Shenzhen (CN)

(21) Appl. No.: 13/920,809

(22) Filed: Jun. 18, 2013

Related U.S. Application Data
(63) Continuation of application No. PCT/CN2010/079995, filed on Dec. 20, 2010.

(51) Int. Cl. G06F 17/30

(52) U.S. Cl. CPC G06F 17/30038
USPC 707/749

(57) ABSTRACT

The present invention discloses a method and apparatus for intelligently deploying an application, a method and apparatus for processing application access, a system for intelligently deploying and scheduling an application. The intelligent deployment method includes: receiving an application which is uploaded by a user through a deployment portal (101); establishing file meta data of the application according to an application identifier of the application, and storing the application in a network storage system (102); classifying the application according to the file meta data, and adding a classification tag (103); and establishing, according to the classification tag, an index relationship between the application and an application server for processing the application (104). Embodiments of the present invention may solve a problem of a waste of storage resources in the prior art and improve utilization of the application server.

### CROSS-REFERENCE TO RELATED APPLICATIONS

This application is a continuation of International Application No. PCT/CN2010/079995, filed on Dec. 20, 2010, which is hereby incorporated by reference in its entirety.

### TECHNICAL FIELD

The present invention relates to the field of computer communication technologies, and in particular, to a method and apparatus for intelligently deploying an application, a method and apparatus for processing application access, a system for intelligently deploying and scheduling an application.

### BACKGROUND

WEB HOSTING is a web hosting service, which allows a person and an organization to deploy their own webs on the World Wide Web, so that another user can access the webs through the Internet (Internet). Generally, a web hosting company owns a data center, and leases resources of the data center, such as a computing resource (host) and network bandwidth, to a customer. An existing WEB HOSTING technology is generally based on a virtual host. That is, a host server (WEB server) running on the Internet is divided into multiple “virtual” servers, which are the so-called virtual hosts, by using a special software and hardware technology. Therefore, each virtual host has an independent domain name and complete Internet server (such as WWW, FTP, and Email) functions. A WEB HOSTING operator achieves independence between users by allocating different virtual hosts to different users.

Generally, WEB HOSTING is divided into two processes, namely, application deployment and application access. The application deployment refers to that a user deploys an application to be deployed by the user to a virtual host of the user. The application access refers to that an Internet user accesses an application deployed by a HOSTING user through a specified URL (domain name). A specific process is as follows:

A HOSTING user uploads an application to an application server through a deployment portal provided by a WEB HOSTING operator. The deployment portal may be an HTTP webpage, an FTP client or the like. The application server deploys the application to a file system in a corresponding WEB server through a deployment system, which specifically includes: binding a local address of the application of the user (a file address of the WEB server) with a domain name of the user; configuring information related to access of the user, such as timeout connection and security configuration; and storing the application uploaded by the user in a corresponding position according to the binding relationship in the previous step, and providing an access privilege externally. Generally, each user has one unique file path, and files uploaded by different users are stored in different positions.

Afterwards, an Internet user sends a WEB request to the web server through a browser according to a URL advertised by the HOSTING user, so as to access the application of the HOSTING user. The browser is a commonly used Internet browser, such as IE and Firefox. A WEB request forwarding unit in the WEB server forwards the WEB request to a corresponding WEB request processing unit according to the request address; and the WEB request processing unit parses a corresponding file from the file system according to correspondence between the URL and the file path after receiving the WEB request, and returns a parsing result to the user.

The inventor of the present invention finds that a large amount of same applications exist in the Internet currently. According to an existing deployment manner, because different users use different paths for storing applications, a large amount of same files may exist in the file system, thereby causing a waste of storage resources of the system. For accesses to a same application, due to different URLs, same file requests are distributed to different servers for processing, thereby lowering processing efficiency of the application server.

### SUMMARY

In view of this, embodiments of the present invention provide a method and apparatus for intelligently deploying an application, a method and apparatus for processing application access, a system for intelligently deploying and scheduling an application, so as to intelligently deploy an application stored in a web hosting service, thereby improving processing efficiency of an application server and an access speed of an application.

To solve this technical problem, an embodiment of the present invention provides a method for intelligently deploying an application, where the method includes:

receiving an application which is uploaded by a user through a deployment portal; establishing file meta data of the application according to an application identifier of the application, and storing the application in a network storage system;

classifying the application according to the file meta data, and adding a classification tag; and

establishing, according to the classification tag, an index relationship between the application and an application server for processing the application.

An embodiment of the present invention provides a method for processing application access, where the method includes:

receiving an application access request sent by a user;

obtaining a request processing unit for processing an application by querying an application management unit according to an application identifier of the application access request, and forwarding the application access request to the request processing unit;

acquiring, by the request processing unit, corresponding file meta data from a file management unit according to the application identifier; and

acquiring, by the request processing unit, a file to be processed actually from a network storage system according to the file meta data, and feeding back the file.

Accordingly, an embodiment of the present invention further provides an apparatus for intelligently deploying an application, where the apparatus includes:

a file management unit, configured to receive an application which is uploaded by a user through a deployment portal, establish file meta data of the application according to an application identifier of the application, and store the application in a network storage system; and

an application management unit, configured to classify the application according to the file meta data, add a classification tag, and establish, according to the classification tag, an index relationship between the application and an application server for processing the application.

An embodiment of the present invention further provides an apparatus for processing application access, where the apparatus includes:

a request forwarding unit, configured to receive an application access request sent by a user, obtain a request processing unit for processing an application by querying an application management unit according to an application identifier of the application access request, and forward the application access request to the request processing unit; and

the request processing unit, configured to acquire corresponding file meta data from a file management unit according to the application identifier, find a file to be processed actually from a network storage system according to the file meta data, and feed back the file.

An embodiment of the present invention further provides a system for intelligently deploying and scheduling an application, where the system includes: an apparatus for intelligently deploying an application and an apparatus for processing application access. For the apparatus for intelligently deploying an application and the apparatus for processing application access, reference may be made to the foregoing description, and details are not repeatedly described herein.

In the embodiments of the present invention, during an application deployment process, for a received application, file meta data of the application is established first according to an application identifier of the application; the application is stored in a network storage system; the application is classified according to the file meta data; and an index relationship between the application and an application server for processing the application is established according to the classification tag. In the embodiments of the present invention, during the application deployment process, an application can be stored according to file meta data of the application, the application can be classified, a classification tag can be added, and an index relationship between the application and an application server for processing the application can be established according to the classification tag, and applications of a same type can be deployed in a same node (or cluster), so as to implement intelligent deployment, thereby saving a computing resource of the server and improving the access speed of the application. Further, before the application is stored, whether the application is stored in the system is determined first according to the file meta data of the application, thereby avoiding repeated deployment of the application and saving storage space of the system.

### BRIEF DESCRIPTION OF DRAWINGS

FIG. 1 is a flow chart of a method for intelligently deploying a web hosting service according to an embodiment of the present invention;

FIG. 2 is a flow chart of a method for processing application access according to an embodiment of the present invention;

FIG. 3 is a schematic structural diagram of an apparatus for intelligently deploying an application according to an embodiment of the present invention;

FIG. 4 is a schematic structural diagram of another apparatus for intelligently deploying an application according to an embodiment of the present invention;

FIG. 5 is a specific schematic structural diagram of an apparatus for intelligently deploying an application according to an embodiment of the present invention;

FIG. 6 is a schematic structural diagram of an apparatus for processing application access according to an embodiment of the present invention;

FIG. 7 is a schematic structural diagram of a system for intelligently deploying and scheduling an application according to an embodiment of the present invention;

FIG. 8 is a schematic structural diagram of an application example of a system for intelligently deploying and scheduling an application according to an embodiment of the present invention;

FIG. 9 is a flow chart of an application example of a method for intelligently deploying an application according to an embodiment of the present invention;

FIG. 10 is a schematic diagram of a file index relationship shown in FIG. 9;

FIG. 11 is a schematic diagram of an index relationship between an application and an application server shown in FIG. 9; and

FIG. 12 shows an application example of a method for processing application access according to an embodiment of the present invention.

### DESCRIPTION OF EMBODIMENTS

The following describes embodiments of the present invention in detail with reference to the accompanying drawings.

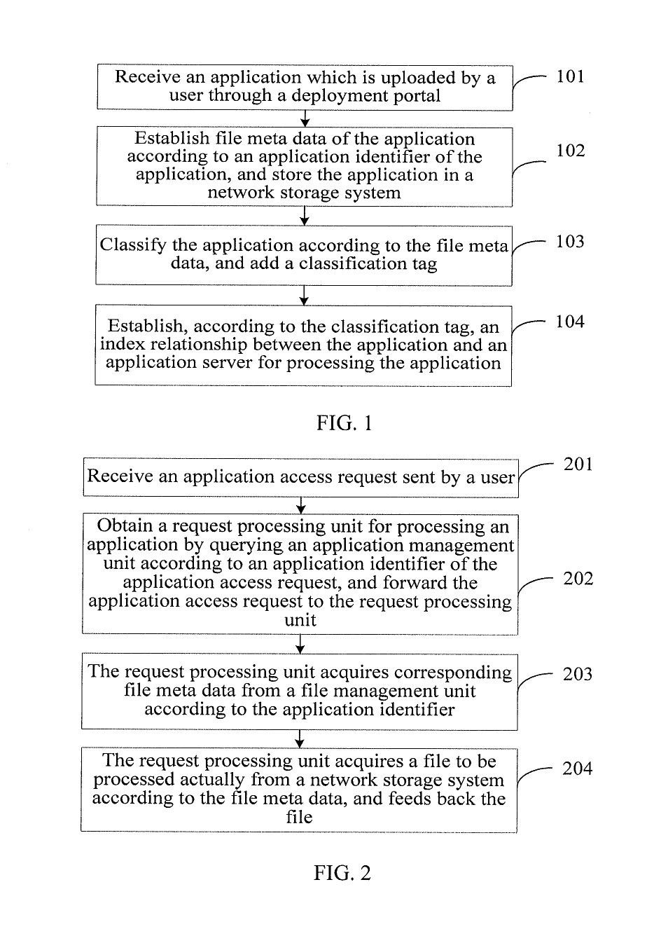

Referring to FIG. 1, FIG. 1 is a flow chart of a method for intelligently deploying a web hosting service according to an embodiment of the present invention. The method includes:

Step 101: Receive an application which is uploaded by a user through a deployment portal.

Step 102: Establish file meta data of the application according to an application identifier of the application, and store the application in a network storage system.

The establishing each piece of file meta data of the application includes: determining each piece of file meta data, where the file meta data includes, but is not limited to: an application identifier, a file path and a file identification code; and then establishing a bidirectional index relationship between the application identifier and the file path (that is, a file identifier) and a unidirectional index relationship between the file identifier (that is, the file path) and the file identification code.

One manner for determining the file identification code of each file includes, but is not limited to: calculating an MD5 code of each file content and using the MD5 code as the file identification code.

Step 103: Classify the application according to the file meta data, and add a classification tag.

One classification method is: analyzing information of the file meta data, to establish a similarity between applications; and classifying the application according to the similarity between applications, and adding a classification tag.

Step 104: Establish, according to the classification tag, an index relationship between the application and an application server for processing the application.

It specifically includes: determining the file meta data of the application, where the file meta data includes: the application identifier, the file path and the file identification code; and establishing a bidirectional index relationship between the application identifier and the file identifier and a unidirectional index relationship between the file path and the file identification code.

Preferably, the method may further include: determining, according to the file identification code in the file meta data, whether the network storage system stores the application, if yes, not storing the application repeatedly, and performing step 103 and step 104; otherwise, performing the step of storing the application in the network storage system.

Preferably, the method may further include:

determining, according to the application identifier, whether the application is a template application, where the template application refers to a large amount of same typical applications, if yes, performing optimization processing on each file in the application, where the optimization of the application is to convert the application into a dynamic link library, an executable file (a binary file), a class file or the like by using a parsing engine; a conversion manner is similar to that in which a java virtual machine converts a java file into a class file or that in which a php interpreter converts a php file into a binary file or the like; and after the processing, performing step 103, that is, classifying the application and adding the classification tag; otherwise, directly performing step 103, that is, classifying the application and adding the classification tag.

In the embodiment of the present invention, during an application deployment process, the application is classified according to the file meta data of the application, the classification tag is added, and the index relationship between the application and the application server for processing the application is established according to the classification tag. That is to say, in the embodiment of the present invention, similar applications are scheduled to a same server by using an intelligent policy, so as to avoid repeated deployment of a same application, thereby saving storage resources of the system, and at the same time, improving efficiency of accessing the application server by the user.

Further, in the embodiment of the present invention, during the application deployment process, whether the application is a template application may also be determined, and compilation (or interpretation) optimization is provided for the template application, thereby improving an access speed.

Further, referring to FIG. 2, FIG. 2 is a flow chart of a method for processing application access according to an embodiment of the present invention. The method includes:

Step 201: Receive an application access request sent by a user.

Step 202: Obtain a request processing unit for processing an application by querying an application management unit according to an application identifier of the application access request, and forward the application access request to the request processing unit.

One determining manner includes: sending a query request to an application management unit in a server for intelligently deploying an application, where the query request includes the application identifier; and Obtaining the request processing unit which is used for processing the application and is fed back by the application management unit.

Step 203: The request processing unit acquires corresponding file meta data from a file management unit according to the application identifier.

One manner of acquiring the meta data is: The request processing unit sends a request of acquiring file meta data corresponding to the classification tag to a file management unit in the server for intelligently deploying an application; and the request processing unit receives the corresponding file meta data fed back by the file management unit.

Step 204: The request processing unit acquires a file to be processed actually from a network storage system according to the file meta data and feeds back the file.

In the embodiment of the present invention, during an application access process, applications of a same type are scheduled to a same application server (or cluster) through intelligent access scheduling, thereby saving a computing resource of the server and improving an access speed of the application.

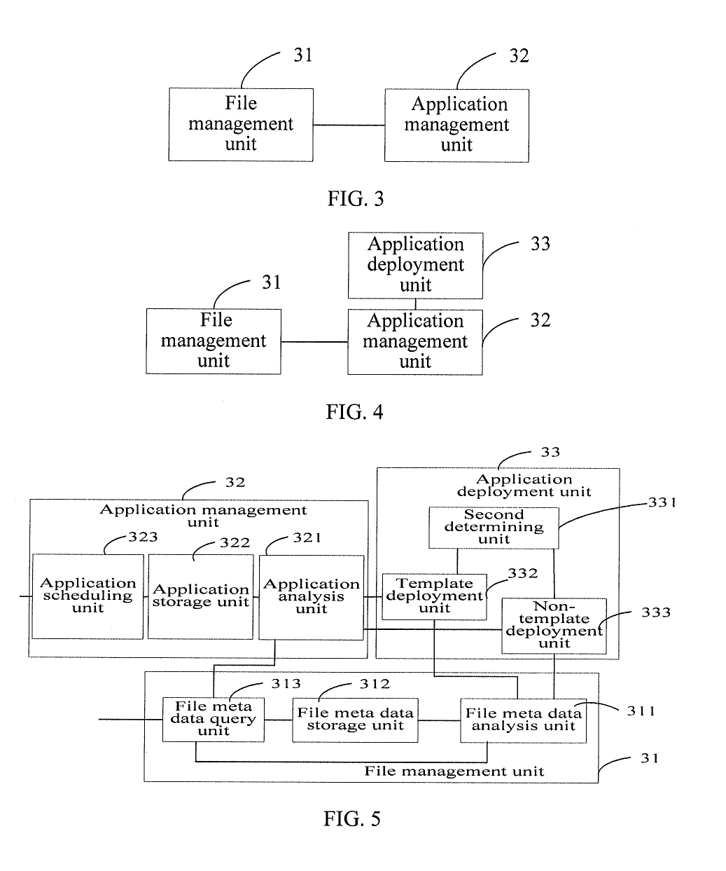

Correspondingly, an embodiment of the present invention further provides an apparatus for intelligently deploying an application. For its schematic structural diagram, refer to FIG. 3. The apparatus for intelligently deploying an application includes: a file management unit 31 and an application management unit 32, where the file management unit 31 is configured to receive an application which is uploaded by a user through a deployment portal, establish file meta data of the application according to an application identifier of the application, and store the application in a network storage system; and the application management unit 32 is configured to classify the application according to the file meta data, add a classification tag, and establish, according to the classification tag, an index relationship between the application and an application server for processing the application.

Preferably, the apparatus for intelligently deploying an application may further include: an application deployment unit 33. For its schematic structural diagram, refer to FIG. 4. The application deployment unit 33 is configured to determine whether the application is a template application, if yes, perform optimization processing on each file in the application, and send each file in the application after the optimization processing to the file management unit, otherwise, directly send the application to the file management unit; and send the application identifier of the application to the application management unit.

The file management unit 31 is further configured to receive the application sent by the application deployment unit, and establish the file meta data of the application according to the application identifier of the application.

The application management unit 32 is further configured to query the file meta data of the application from the file management unit according to the received application identifier.

Preferably, the apparatus may further include: a first determining unit, configured to determine, according to a file identification code in the file meta data, whether the network storage system stores the application, if yes, not store the data repeatedly; otherwise, instructa file meta data storage unit to store the application.

The file meta data storage unit is further configured to store the application in the network storage system when receiving a notification sent by the first determining unit.

The application deployment unit 33 includes: a second determining unit 331, a template deployment unit 332 and a non-template deployment unit 333. For its schematic structural diagram, refer to FIG. 5. The second determining unit 331 is configured to determine whether the application is a template application; the template deployment unit 332 is configured to: when the second determining unit determines that the application is a template application, perform optimization processing on each file in the application, send each file in the application after the optimization processing to the file management unit, and send the application identifier of the application to the application management unit; and the non-template deployment unit 333 is configured to: when the second determining unit determines that the application is a non-template application, send the application to the file management unit and send the application identifier of the application to the application management unit.

The file management unit 31 includes: a file meta data analysis unit 311, a file meta data storage unit 312 and a file meta data query unit 313. For its schematic structural diagram, refer to FIG. 5. The file meta data analysis unit 311 is configured to receive an application uploaded by a user, analyze the application, establish file meta data of the application and an index relationship of the application according to an application identifier of the application, and store the application in a network storage system, where the meta data includes: an application identifier, a file path and a file identification code, and the index relationship includes a bidirectional index relationship between the application identifier and a file identifier and a unidirectional index relationship between the file path and the file identification code; the file meta data storage unit 312 is configured to store the file meta data of the application and the index relationship of the application; and the file meta data query unit 313 is configured to provide a query function externally, so that the application management unit queries for the meta data.

Preferably, the file meta data query unit 313 is further configured to query whether the file meta data storage unit stores corresponding file meta data; and the file meta data storage unit 312 is further configured to: when the file meta data query unit does not obtain the corresponding file meta data through querying, store the file meta data and the index relationship of the application.

The application management unit 32 includes an application analysis unit 321 and an application storage unit 322, and may further include an application scheduling unit 323. For its schematic structural diagram, refer to FIG. 5. The application analysis unit 321 is configured to acquire corresponding file meta data according to the application identifier, classify the application according to the file meta data, and add the classification tag; the application storage unit 322 is configured to establish an index relationship between the application and a corresponding application server according to the classification tag added by the application analysis unit 321; and the application scheduling unit 323 is configured to: when a query request is received, query, according to the application identifier of the application, for an address of the application server for processing the application, and feed back the address of the application server that is obtained through querying.

That is to say, in this embodiment, the application deployment unit 33 is configured to deploy an application uploaded by a user to a server for intelligently deploying an application (such as a WEB server) of an operator. That is, uploaded applications are classified into two types, namely a template application and a non-template application. For the template application, optimization processing is directly performed on the application. Specific optimization processing may be: converting the application into a dynamic link library, an executable file (a binary file), a class file or the like by using a parsing engine. An optimization processing manner is similar to, but is not limited to, that in which a Java virtual machine converts a Java file into a class file or that in which a php interpreter converts a php file into a binary file or the like. Then, send the file in the application after the optimization to the file management unit 31 and instruct the application management unit 32 to add the application. For the non-template application, the application deployment unit 33 directly sends the file in the application to the file management unit 31 for processing and notifies the application management unit 32 of adding the application.

The file management unit 31 is specifically configured to receive the file (or the file identifier) which is of the application and is sent by the application deployment unit 33, and first establish file meta data for each file in the application. In this embodiment, the file meta data refers to a file storing a file related attribute; in a file system, the file meta data generally refers to an address where file content is stored in a disk; and in the present invention, the file meta data refers in particular to an application identifier of a file, a relative path of an application (that is, an application path), a file identifier (that is, a file identification code) and a file attribute. Then, store the file meta data, and at the same time, store the application in the network storage system (such as a WEB storage system). At the same time, the file meta data query unit 313 in the file management unit 31 further provides a file meta data query interface externally, and searches, according to the application identifier, for all file identification codes belonging to the application, so as to access the application server to query for related information of the file meta data.

Preferably, before the application is stored in the network storage system, whether the network storage system stores the application may be further determined according to the file identification code in the file meta data. If yes, do not store the application repeatedly; otherwise, store the application in the network storage system.

The application management unit 32 is specifically configured to receive the application identifier which is of the application and is transmitted by the application deployment unit 33; query for file meta data information of the application from the file management unit 31 according to the application identifier; then analyze the application according to the application meta data information to establish a model of a similarity between applications, perform cluster analysis on the application to classify the application, and add a classification tag to the classified application; and then store the application in an application database, and at the same time, establish an index relationship between the application and the application server according to the classification tag. The application scheduling unit is specifically configured to dynamically maintain the index relationship, and at the same time, return an address of a corresponding application server according to a URL of a request.

In the embodiment of the present invention, a new meta data system is established for the deployed application. Same applications are deployed to a same application server by using the similarity between applications, which effectively avoids repeated storage of a same application and avoids repeated parsing of the same application, thereby improving storage efficiency and utilization of the application server.

Further, in the embodiment of the present invention, a template application is established for a large amount of same applications, thereby implementing precompilation of the application and improving an access speed of the application.

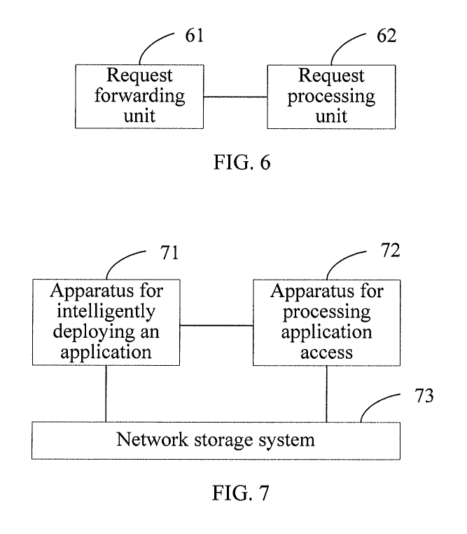

Further, referring to FIG. 6, FIG. 6 is a schematic structural diagram of an apparatus for processing application access according to an embodiment of the present invention. The apparatus for processing application access includes: a request forwarding unit 61 and a request processing unit 62, where the request forwarding unit 61 is configured to receive an application access request sent by a user, obtain a request processing unit of an application by querying an application management unit according to an application identifier of the application access request, and forward the application access request to the request processing unit; and the request processing unit 62, is configured to acquire corresponding file meta data from a file management unit according to the application identifier, and find a file to be processed actually from a network storage system according to the file meta data, and feed back the file.

That is to say, in the embodiment of the present invention, the request forwarding unit 61 is configured to: after a request of a browser is received, interact with the application management unit 32 according to a uniform resource identifier URL of the request, to acquire a request processing unit 62 for processing the application. Then, the request forwarding unit 61 forwards the request to the request processing unit 62. The request processing unit 62 is configured to receive the request forwarded by the request forwarding unit 61, and find file meta data related to the application from the file management unit according to the URL of the request, parse the meta data, and acquire a corresponding file from a Web storage system according to a parsing result, where the file related to the application may be a static file or a dynamic script.

Further, referring to FIG. 7, FIG. 7 is a schematic structural diagram of a system for intelligently deploying and scheduling an application according to an embodiment of the present invention. The system includes: an apparatus 71 for intelligently deploying an application, an apparatus 72 for processing application access and a network storage system 73. In this embodiment, for the function and effect of the apparatus, reference may be made to the foregoing implementation process, and details are not repeatedly described herein.

The network storage system 73, exemplified using a WEB storage system in this embodiment, is configured to store a file system that is applied actually, which may be a file system such as local EXT2, EXT3, FAT32 and NTFS, and may also be a distributed file system, a network file system or the like.

The apparatus 71 for intelligently deploying an application may include an application analysis unit and an application storage unit, and may further include an application scheduling unit, and the apparatus 72 for processing application access may include a request forwarding unit and a request processing unit. For the function and effect of each unit, reference may be made to the foregoing embodiment, and details are not repeatedly described herein.

Preferably, the network storage system may be integrated into a apparatus for intelligently deploying an application or may be deployed independently, which is not limited in the embodiment of the present invention.

The embodiment of the present invention provides a method for implementing intelligent deployment of multiple distributed WEB applications, a method for processing application access, a apparatus for intelligently deploying an application, and a apparatus for processing application access. During a process of deploying a large amount of applications, repeated deployment of a same application can be avoided, thereby saving storage space of the system and reducing deployment costs.

Further, for the template application, compilation (or interpretation) optimization is provided, thereby improving an access speed of the application.

During an application access process, applications of a same type are scheduled to a same node (or cluster) through intelligent access scheduling, thereby improving utilization of resources and improving the access speed of the application.

For ease of understanding by a person skilled in the art, description is given in the following through specific embodiments.

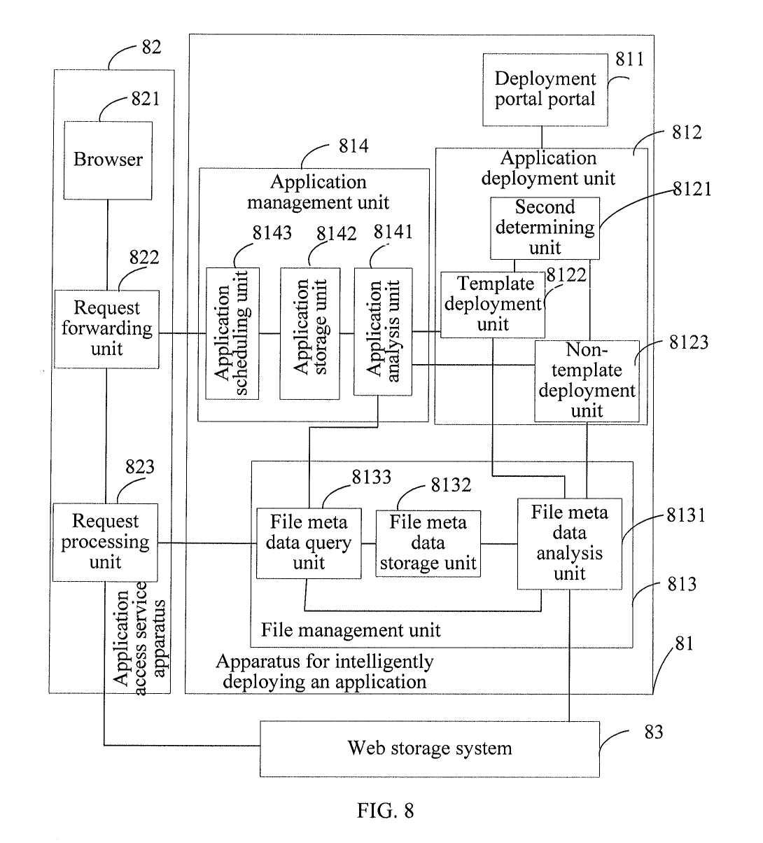

Further, Referring to FIG. 8, FIG. 8 is a schematic structural diagram of an application example of a system for intelligently deploying and scheduling an application according to an embodiment of the present invention. In this embodiment, as an example, a Web storage system is deployed independently. The system includes: an apparatus 81 for intelligently deploying an application, an application access service apparatus 82 and a Web storage system 83.

The apparatus 81 for intelligently deploying an application includes: a deployment portal (portal) 811, an application deployment unit 812, a file management unit 813 and an application management unit 814. The application deployment unit 812 includes: a second determining unit 8121, a template deployment unit 8122 and a non-template deployment unit 8123. The file management unit 813 includes: a file meta data analysis unit 8131 and a file meta data storage unit 8132. The application management unit 814 includes an application analysis unit 8141 and an application storage unit 8142, and may further include an application scheduling unit 8143.

The application access service apparatus 82 includes: a browser (Browser) 821, a request forwarding unit 822 and a request processing unit 823.

As shown in FIG. 8, in the embodiment of the present invention, two processes, namely application deployment and application access, are included, where the application deployment refers to that a HOSTING user deploys an application to be deployed by the HOSTING user to a system provided by a provider; and the application access refers to that an internet user accesses, through a specified URL (domain name), the application deployed by the HOSTING user. The following describes the two processes in details with reference to FIG. 8.

1. Application Deployment Process

The deployment portal 811 is a deployment portal which is provided for a user by a WEB HOSTING operator, and functions to enable the user to upload an application of the user to a WEB server. It may be a WEB page or an FTP client.

The application deployment unit 812 is configured to deploy an application uploaded by a user in a WEB server of an operator. The second determining unit 8121 determines whether the application is a template application. That is, uploaded applications may be classified into two types, namely, a template application and a non-template application. For the template application, the template deployment unit 8122 directly performs optimization processing on the application, then sends a file after the optimization to the file management unit 813, and notifies the application management unit 814 of adding the application, that is, sends a file identifier of the application to the application management unit 814. For the non-template application, the non-template deployment unit 8123 directly delivers a file to the file management unit 813 for processing and notifies the application management unit 814 of adding the application, that is, sends a file identifier of the application to the application management unit 814.

The file meta data analysis unit 8131 in the file management unit 813 is configured to receive the file (or the file identifier) sent by the application deployment unit 812, analyze the application, and establish meta data of each file in the application and an index relationship of the application according to the application identifier of the application. In this embodiment, the file meta data refers to a file storing a file related attribute; in a file system, the file meta data generally refers to an address where file content is stored in a disk; and in the embodiment of the present invention, the file meta data refers in particular to a file attribute such as an application identifier of a file, a relative path of an application (that is, a file path), a file identification code and file content. The file meta data storage unit 8132 stores the file meta data and the index relationship of the application, and stores the analyzed application in the WEB storage system 83. At the same time, the file management unit 813 provides a file meta data query interface externally, so that the application management unit 814 and/or the request forwarding unit 822 queries for related information of the file meta data.

Preferably, before the application is stored in the network storage system, whether the network storage system stores the application may be further determined according to the file identification code in the file meta data. If yes, do not store the application repeatedly; otherwise, store the application in the network storage system.

The application analysis unit 8141 in the application management unit 814 is configured to receive the application identifier transmitted by the application deployment unit 812, query for file meta data information of the application from the file management unit 813 according to the application identifier, analyze the application according to the application meta data information obtained through querying to establish a model of a similarity between applications, perform cluster analysis on the application according to the similarity between the applications, that is, classify the application, and add a classification tag to the application. The application storage unit 8142 is configured to deploy applications having a same tag to a same application server in the network storage system according to the classification tag added by the application analysis unit 8141, and establish an index relationship between the application and a corresponding application server according to the classification tag. The application scheduling unit 8143 in the application management unit 814 dynamically maintains the index relationship, and returns an address of a corresponding application server according to a URL of a request.

The WEB storage system 83 is configured to store a file system that is applied actually, which may be a file system such as local EXT2, EXT3, FAT32 and NTFS, and may also be a distributed file system, a network file system or the like.

2. Application Access Process

The browser 821 refers to an Internet browser of a user, such as IE and Firefox. The user uses the browser to access the Internet, and the browser uses the DNS protocol to acquire an IP address of an access domain name, where an access process using the DNS is generally implemented by an operating system, and an application access server is connected by using the HTTP protocol to acquire an access resource.

The request forwarding unit 822 is configured to: after a request of a browser (that is, the Browser 821) is received, interact with the application management unit 814 according to a uniform resource identifier URL of the request, to acquire a request processing unit for processing the request, and then forward the request to the corresponding request processing unit 823.

The request processing unit 823 is configured to receive the request forwarded by the request forwarding unit 822, find a related application file from the file management unit according to the URL of the request, parse the application file, and then display the parsed file to the user. In this embodiment, the related application file may be a static file or a dynamic script, which is not limited in this embodiment.

3. The following interfaces are involved between the units during the application deployment and application access processes, to which the present invention is not limited, and other interfaces with similar functions may also be involved.

As shown in FIG. 8, an interface V1 is an interface that directly connects the browser 821 and the request forwarding unit 822 (where the request forwarding unit is a server), is based on the HTTP transmission protocol, and generally is a network interface.

An interface V2 is used for interaction between the request forwarding unit 822 and the application management unit 814. The request forwarding unit sends an application URL to the application scheduling unit 8143 in the application management unit 814, and the application scheduling unit 8143 returns an address of a corresponding application server according to the corresponding URL. The interface is mainly used for information interaction between the foregoing two units, and an interaction manner is not limited to a network protocol such as HTTP and TCP, but may be any manner satisfying the interaction.

An interface V3 is an interface between the request forwarding unit 822 and the request processing unit 823, and is used to forward the request of the browser 821. The interface may be an HTTP-based interface or a CGI-based transmission interface, which is not limited in this embodiment.

An interface V4 is an interface used for information interaction between the file management unit 813 and the request processing unit 823.

An interface D1 is a file transmission interface between the deployment portal 811 and the application deployment unit 812, which may be HTTP-based or FTP-based and generally may be any interface capable of implementing file transmission.

An interface D2 is a file interface between the application deployment unit 812 and the file management unit 813. An information transfer manner is not limited to a manner of file copying, but may also be a manner of transferring a file address. All manners satisfying the function may be adopted.

An interface D3 is an interface between the application deployment unit 812 and the application management unit 814, and is used for the application deployment unit 812 to transfer related information of the application to the application management unit 814. A form of the interface D3 is not limited to a message interface, but may also be a file interface. All methods capable of transferring application information may be used.

An interface D4 is an interface between the application management unit 814 and the file management unit 813. The application management unit 814 queries for related information of the meta data of the application from the file management unit 813 through the interface. A form of the interface D4 is not limited to a network interface (such as HTTP and TCP), but may also be a file interface, which is not limited in this embodiment.

An interface D5 is an interface between the file management unit 813 and the Web storage system 83. The interface D5 is an ordinary file read/write interface. The file management unit 813 stores the application in the Web storage system 83 through the interface.

An interface V5 is an interface between the request processing unit 823 and the Web storage system 83, and is an ordinary file read/write interface. The request processing unit 823 acquires an actual application from the Web storage system 83 through the interface.

At the same time, in the intelligent deployment of the application, a query interface is exposed externally, so as to obtain, through querying, the deployed application server according to the application.

In the embodiment of the present invention, during the application deployment process, an application template is established for a large amount of same applications, thereby implementing precompilation of the application and improving an access speed of the application. A new meta data system is established for an application file, which effectively avoids repeated storage of the application file. Further, the present invention further proposes a manner of calculating a similarity between applications, so as to deploy same applications in a same application server. This avoids repeated storage and parsing of a same application, and improves utilization of the application server.

During the application access process, applications of a same type are scheduled to a same node (or cluster) through intelligent access scheduling, thereby saving a computing resource of the server and improving the access speed of the application.

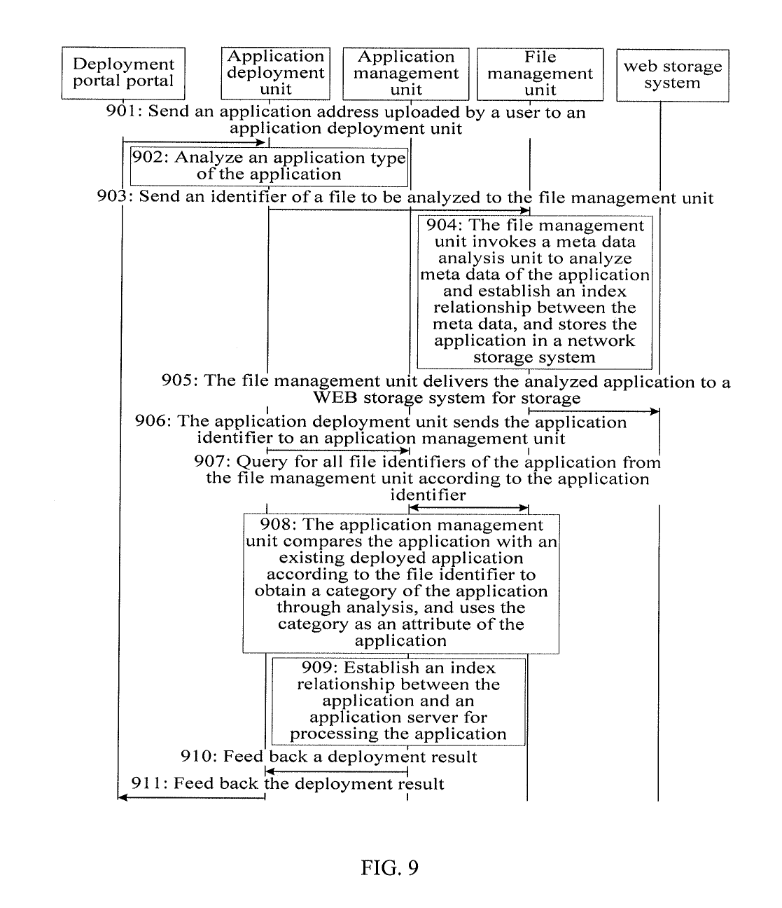

Further, referring to FIG. 9, FIG. 9 is a flow chart of an application example of a method for intelligently deploying an application according to an embodiment of the present invention, where the method specifically includes:

Step 901: A deployment portal sends an application address uploaded by a user to an application deployment unit.

Step 902: The application deployment unit analyzes an application type of the application, which specifically includes: determining whether the application is a template application according to an application identifier of the application; if the application is a template application, delivering the application to a template deployment unit for processing, where the template deployment unit first performs optimization processing on the application to generate a file after the optimization, then directly delivers the file after the optimization to a file management unit for processing; if the application is a non-template application, delivering the application to an ordinary application unit for processing, and directly delivering the application to the file management unit for processing.

In this embodiment, the optimization processing performed on the application is to convert the application into a dynamic link library, an executable file (a binary file), a class file or the like by using a parsing engine. A conversion manner is similar to that in which a java virtual machine converts a java file into a class file or that in which a php interpreter converts a php file into a binary file or the like. A main purpose of the optimization processing is to accelerate processing of the server. A file which is not optimized is stored in a hard disk, and when being accessed, is loaded by a service program to a memory for processing, while a file which is optimized is directly loaded to the memory for processing, thereby improving a processing speed of the server.

Step 903: The application deployment unit sends an identifier of a file to be analyzed to the file management unit, where the file identifier includes, but is not limited to, a file path.

Step 904: The file management unit invokes a meta data analysis unit to analyze meta data of the application and establish an index relationship between the meta data, and stores the application in a network storage system.

The meta data includes: an application identifier, a file path and a file identification code, and a bidirectional index relationship between the application identifier and the file identifier and a unidirectional index relationship between the file path and the file identification code are established.

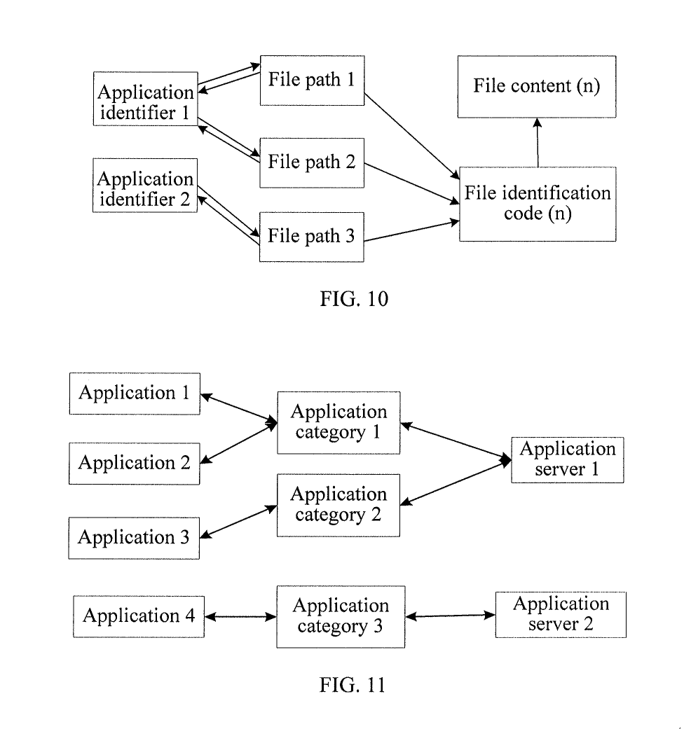

One preferred manner is: calculating an MD5 code of each file content, using the MD5 code of each file content as a file identification code, and establishing a file index relationship for the application according to the meta data, that is, establishing a bidirectional index relationship between the application identifier and the file identifier (that is, the file path) and a unidirectional index relationship between the file path and the file identification code, specifically as shown in FIG. 10. In FIG. 10, an arrow in the figure represents an index direction.

At the same time, the file meta data storage unit stores the index relationship, and the file meta data query unit provides an advanced query function externally, which is, for example, but is not limited to, searching for all file identification codes belonging to the application according to the application identifier, and arranging the file identification codes according to a specified sequence.

Step 905: The file management unit delivers the analyzed application to a WEB storage system for storage.

One preferred manner is: storing the file identifier as a file name in the WEB storage system. For example, if an identifier of a file temp.php is a2344312dswefsf, a storage manner is to copy content of the file temp.php to a file a2344312dswefsf. If the identifier already exists, the file does not need to be stored in the WEB storage system. In this way, a problem of repeated storage of the file is effectively avoided.

Step 906: The application deployment unit sends the application identifier to an application management unit. The application identifier includes, but is not limited to, an application ID. A sending method is not limited to network transmission.

Step 907: The application management unit queries for all file paths (such as file identifiers) of the application from the file management unit according to the application identifier, and uses the file identifier as a basis for classifying the application.

Step 908: The application management unit compares the application with an existing deployed application according to the file identifier to obtain a category of the application through analysis, and uses the category as an attribute of the application.

One optional manner for classifying the application is as follows:

1. If there is only one application, the application itself is a category. A category identifier is added to the application and the application is used as a reference application of the category.

2. When there is a new application, a application similarity is calculated according to the following method:

1) acquiring all file identification codes of the new application according to an application identifier;

2) randomly selecting a part (such as 10%-20%) of the file identification codes in the application; and

3) determining, by searching a reference application of an existing application classification according to the application identifier, whether the file identifier exists. If 80% of the file identifiers exist, it is considered that the application belongs to the category. If it is not similar to an existing application, a new category is added.

Step 909: Establish, according to the classification tag, an index relationship between the application and an application server for processing the application. The index relationship is specifically as shown in FIG. 11.

In this figure, multiple applications may correspond to one application category, multiple application categories may correspond to one application server. That is to say, through similarity analysis, applications of a same type are deployed to a same application server, and an index relationship between the application, the application category and the application server is established.

Step 910: The application management unit feeds back a deployment result to the application deployment unit.

Step 911: The application deployment unit feeds back the deployment result to the deployment portal and the deployment portal displays the deployment result to the user.

At the same time, in the server for intelligently deploying an application, a query interface is exposed externally, so that a deployed server may be obtained through querying according to the application.

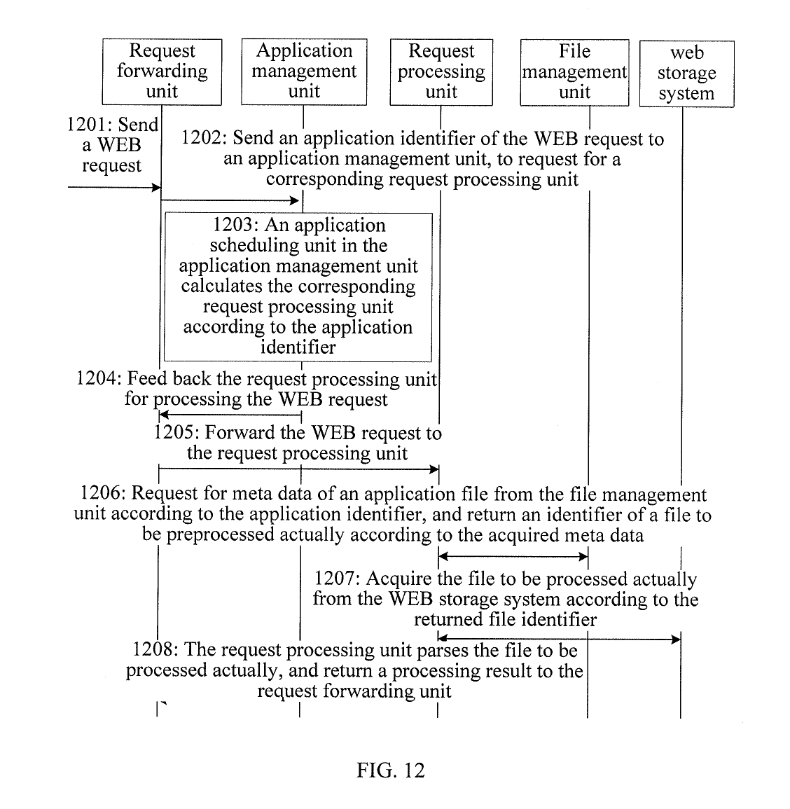

Further, referring to FIG. 12, FIG. 12 is an application example of a method for processing application access according to an embodiment of the present invention, where the method specifically includes:

Step 1201: A browser sends a WEB request to a request forwarding unit.

Step 1202: The request forwarding unit sends an application identifier of the WEB request to an application management unit, to request for a corresponding request processing unit.

Step 1203: An application scheduling unit in the application management unit calculates the corresponding request processing unit according to the application identifier.

When calculating the corresponding request processing unit, the application scheduling unit may query a corresponding application server according to an index generated for the first time during an application deployment process, and at the same time, may also dynamically adjust the index according to a load situation of a non-template deployment unit. For example, two request processing units are allocated when applications of one type are deployed. However, the number of applications of this type increases gradually as time goes on, and the deployed two request application units cannot meet an application processing requirement. When the application scheduling unit has detected this phenomenon, the application scheduling unit adds a corresponding request processing unit, and at the same time, modifies an index table of the application. In this way, a subsequent request regarding applications of this type is scheduled to the newly-added request processing unit.

Step 1204: The application management unit feeds back the request processing unit for processing the WEB request to the request forwarding unit.

Step 1205: The request forwarding unit forwards the WEB request to the request processing unit.

Step 1206: The request processing unit requests for meta data of an application file from the file management unit according to the application identifier, and returns an identifier of a file to be processed actually according to the acquired meta data.

Step 1207: The request processing unit acquires the file to be processed actually from the WEB storage system according to the returned file identifier.

Step 1208: The request processing unit parses the file to be processed actually, and returns a processing result to the request forwarding unit (or a user browser).

In this embodiment, a process of feeding back the processing result is implemented according to a rule of forwarding the request. In case of URL redirection, the result is directly returned to the browser. In case of server-side redirection, the result is returned to the request forwarding unit.

In addition, during an implementation process of the embodiment of the present invention, if a large amount of applications need to be deployed simultaneously, problems of slow deployment and an excessively high system load may be caused. On the basis of the embodiment of the present invention, an off-line analysis manner may be adopted for improvement. That is, when the user performs deployment according to the prior art, if a load of a server is low, the application deployment unit automatically optimizes an application which is deployed according to the prior art, thereby solving the problems of the slow deployment and the excessively high system load when a large amount of applications need to be deployed simultaneously.

In the embodiment of the present invention, a new meta data system is established for the deployed application. Applications of a same type are deployed to a same node by using a similarity between applications to implement intelligent deployment, thereby saving a computing resource of the server and improving an access speed of the application. Further, before the application is stored, whether the application is already stored in the system is determined according the file meta data of the application, thereby effectively avoiding repeated storage of a same application and repeated parsing of the same application, and improving storage efficiency and utilization of the application server.

Further, in the embodiment of the present invention, a template application is established for a large amount of same applications, thereby implementing precompilation of the application, that is, improving an access speed of the application through a template technology.

Apparently, a person skilled in the art should understand that the units or steps in the present invention may be implemented through a universal computing apparatus, and they may be integrated on a single computing apparatus, or distributed on a network formed by multiple computing apparatuses. Optionally, they may be implemented by using executable program codes of the computing apparatus, so that they can be stored in a storage apparatus and executed by the computing apparatus, or they may be implemented by being fabricated into integrated circuit units or by fabricating multiple units or steps among them into a single integrated circuit unit. In this way, the present invention is not limited to any specific combination of hardware and software.

The foregoing description is merely exemplary embodiments of the present invention, but is not intended to limit the protection scope of the present invention. Any modification, equivalent replacement, or improvement made within the spirit and principle of the present invention shall fall within the protection scope of the present invention.

1. A method comprising:
receiving an application is uploaded through a deployment portal;
establishing file meta data of the application according to an application identifier of the application, and storing the application in a network storage system;
classifying the application according to the file meta data, and adding a classification tag; and
establishing, according to the classification tag, an index relationship between the application and an application server for processing the application.

2. The method according to claim 1, wherein classifying the application according to the file meta data, and adding a classification tag comprises:
analyzing information of the file meta data, to establish a similarity between applications; and
classifying the application according to the similarity between applications, and adding the classification tag.

3. The method according to claim 1, wherein establishing file meta data of the application comprises:
determining the file meta data of the application, wherein the file meta data comprises: an application identifier, a file path and a file identification code; and
establishing a bidirectional index relationship between the application identifier and a file identifier and a unidirectional index relationship between the file path and the file identification code.

4. The method according to claim 3, wherein determining a file identification code in the file meta data of the application specifically comprises:
calculating an MD5 code of each file content in the application, and using the MD5 code as the file identification code.

5. The method according to claim 4, further comprising:
determining, according to the file identification code in the file meta data, whether the network storage system stores the application, if yes, not storing the application repeatedly; otherwise, performing the step of storing the application in the network storage system.

6. The method according to claim 1, further comprising:
determining whether the application is a template application, if yes, performing optimization processing on each file in the application, and after the optimization processing, performing the step of classifying the application according to the file meta data and adding the classification tag; otherwise, directly performing the step of classifying the application and adding the classification tag.

7. The method according to claim 6, wherein performing optimization processing on each file in the application comprises:
converting the application into a dynamic link library by using a parsing engine.

8. A method for processing application access, comprising:
receiving an application access request;
obtaining a request processing unit for processing an application by querying an application management unit according to an application identifier of the application access request, and forwarding the application access request to the request processing unit;
acquiring, by the request processing unit, corresponding file meta data from a file management unit according to the application identifier; and
acquiring, by the request processing unit, a file to be processed actually from a network storage system according to the file meta data, and feeding back the file.

9. An apparatus comprising:
a file management unit, configured to receive an application uploaded through a deployment portal, establish file meta data of the application according to an application identifier of the application, and store the application in a network storage system; and
an application management unit, configured to classify the application according to the file meta data, add a classification tag, and establish, according to the classification tag, an index relationship between the application and an application server for processing the application.

10. The apparatus according to claim 9, wherein the file management unit comprises:
a file meta data analysis unit, configured to receive an application, analyze the application, establish file meta data of the application and an index relationship of the application according to an application identifier of the application, and store the application in a network storage system, wherein the file meta data comprises: an application identifier, a file path and a file identification code; and the index relationship comprises: a bidirectional index relationship between the application identifier and a file identifier and a unidirectional index relationship between the file path and the file identification code;
a file meta data storage unit, configured to store the file meta data of the application and the index relationship of the application; and
a file meta data query unit, configured to provide a query function externally, so that the application management unit queries for the meta data.

11. The apparatus according to claim 10, wherein the file meta data query unit is further configured to query whether the file meta data storage unit stores corresponding file meta data; and
the file meta data storage unit is further configured to: when the file meta data query unit does not obtain the corresponding file meta data through querying, store the file meta data and the index relationship of the application.

12. The apparatus according to claim 11, further comprising:
a first determining unit, configured to determine, according to the file identification code in the file meta data, whether the network storage system stores the application, if yes, not store the application repeatedly; otherwise, instruct the file meta data storage unit to store the application; and
the file meta data storage unit is further configured to store the application in the network storage system when receiving a notification sent by the first determining unit.

13. The apparatus according to claim 9, wherein the application management unit comprises:
an application analysis unit, configured to acquire corresponding file meta data according to the application identifier, classify the application according to the file meta data, and add the classification tag; and
an application storage unit, configured to establish, according to the classification tag added by the application analysis unit, an index relationship between the application and an application server for processing the application.

14. The apparatus according to claim 13, wherein the application management unit further comprises:
an application scheduling unit, configured to: when a query request is received, query, according to the application identifier of the application, for an address of the application server for processing the application, and feed back the address of the application server that is obtained through querying.

15. The apparatus according to claim 9, further comprising:
an application deployment unit, configured to determine whether the application is a template application, if yes, perform optimization processing on each file in the application, and send each file in the application after the optimization processing to the file management unit, otherwise, directly send the application to the file management unit; and send the application identifier of the application to the application management unit, wherein
the file management unit is further configured to receive the application sent by the application deployment unit, and establish the file meta data of the application according to the application identifier of the application; and
the application management unit is further configured to query the file meta data of the application from the file management unit according to the received application identifier.

16. The apparatus according to claim 15, wherein the application deployment unit comprises:
a second determining unit, configured to determine whether the application is a template application;
a template deployment unit, configured to: when the second determining unit determines that the application is a template application, perform optimization processing on each file in the application, send each file in the application after the optimization processing to the file management unit, and send the application identifier of the application to the application management unit; and
a non-template deployment unit, configured to: when the second determining unit determines that the application is a non-template application, send the application to the file management unit, and send the application identifier of the application to the application management unit.

17. An apparatus for processing application access, comprising:
a request forwarding unit, configured to receive an application access request, obtain a request processing unit for processing an application by querying an application management unit according to an application identifier of the application access request, and forward the application access request to the request processing unit; and
the request processing unit, configured to acquire corresponding file meta data from a file management unit according to the application identifier, find a file to be processed actually from a network storage system according to the file meta data, and feed back the file.

18. (canceled)
